(19) United States
(12) Patent Application Publication
(10) Pub. No.: US 2014/0254215 A1
(43) Pub. Date: Sep. 11, 2014

(54) CONTROLLER FOR A POWER CONVERTER AND METHOD OF OPERATING THE SAME

(71) Applicant: Power Systems Technologies Ltd., Ebene (MU)

(72) Inventors: Antony Brinlee, Plano, TX (US); Ralf Schroeder genannt Berghegger, Glandorf (DE)

(73) Assignee: Power Systems Technologies Ltd., Ebene (MU)

(21) Appl. No.: 14/260,467

(22) Filed: Apr. 24, 2014

Related U.S. Application Data
(63) Continuation-in-part of application No. 13/220,510, filed on Aug. 29, 2011.

(51) Int. Cl. H02M 3/335

(52) U.S. Cl. CPC H02M 3/33507
USPC 363/21.15

(57) ABSTRACT

A control system for a power converter with reduced power dissipation and method of operating the same. In one embodiment, the control system includes a first controller coupled to a primary winding of a transformer and configured to control a duty cycle of a power switch to regulate an output characteristic of the power converter. The control system also includes a second controller configured to provide a signal to one of a secondary winding of the transformer and a circuit element spanning an isolation boundary of the transformer in response to a dynamic change of the output characteristic to trigger the first controller to initiate the duty cycle for the power switch.

### RELATED APPLICATIONS

This application is a continuation-in-part of U.S. patent application Ser. No. 13/220,510, entitled “Controller for a Power Converter and Method of Operating the Same,” filed on Aug. 29, 2011, which is incorporated herein by reference.

### TECHNICAL FIELD

The present invention is directed, in general, to power electronics and, more specifically, to a power converter with reduced power dissipation at light loads.

### BACKGROUND

A switched-mode power converter (also referred to as a “power converter”) is a power supply or power processing circuit that converts an input voltage waveform into a specified output voltage waveform. DC-DC power converters convert a direct current (“dc”) input voltage into a dc output voltage. Controllers associated with the power converters manage an operation thereof by controlling conduction periods of power switches employed therein. Generally, the controllers are coupled between an input and output of the power converter in a feedback loop configuration (also referred to as a “control loop” or “closed control loop”).

Typically, the controller measures an output characteristic (e.g., an output voltage, an output current, or a combination of an output voltage and an output current) of the power converter, and based thereon modifies a duty cycle of a power switch of the power converter. The duty cycle “D” is a ratio represented by a conduction period of a power switch to a switching period thereof. In other words, the switching period includes the conduction period of the power switch (represented by the duty cycle “D”) and a non-conduction period of the power switch (represented by the complementary duty cycle (“1-D”). Thus, if a power switch conducts for half of the switching period, the duty cycle for the power switch would be 0.5 (or 50 percent). Additionally, as the voltage or the current for systems, such as a microprocessor powered by the power converter, dynamically change (e.g., as a computational load on the microprocessor changes), the controller should be configured to dynamically increase or decrease the duty cycle of the power switches therein to maintain an output characteristic such as an output voltage at a desired value.

Power converters designed to operate at low power levels typically employ a flyback power train topology to achieve low manufacturing cost. A power converter with a low power rating designed to convert alternating current (“ac”) mains voltage to a regulated dc output voltage to power an electronic load such as a printer, modem, or personal computer is generally referred to as a “power adapter” or an “ac adapter.”

Power conversion efficiency for power adapters has become a significant marketing criterion, particularly since the publication of recent U.S. Energy Star specifications that require a power conversion efficiency of power adapters for personal computers to be at least 50 percent at very low levels of output power. The “One Watt Initiative” of the International Energy Agency is another energy saving initiative to reduce appliance standby power to one watt or less. These efficiency requirements at very low output power levels were established in view of the typical load presented by a printer in an idle or sleep mode, which is an operational state for a large fraction of the time for such devices in a home or office environment. A challenge for a power adapter designer is to provide a high level of power conversion efficiency (i.e., a low level of power adapter dissipation) over a wide range of output power.

Numerous strategies have been developed to reduce manufacturing costs and increase power conversion efficiency of power converters over a wide range of output power levels, including the incorporation of a burst operating mode at very low output power levels. Other strategies include employing an energy-recovery snubber circuit or a custom integrated controller, and a carefully tailored specification. Each of these approaches, however, provides a cost or efficiency limitation that often fails to distinguish a particular vendor in the marketplace. Thus, despite continued size and cost reductions of components associated with power conversion, no satisfactory strategy has emerged to reduce power converter dissipation at low load currents.

Accordingly, what is needed in the art is a circuit and related method for a power converter that enables a further reduction in manufacturing cost while reducing power converter power dissipation, particularly at low load currents, that does not compromise end-product performance, and that can be advantageously adapted to high-volume manufacturing techniques for power adapters and other power supplies employing the same.

### SUMMARY OF THE INVENTION

These and other problems are generally solved or circumvented, and technical advantages are generally achieved, by advantageous embodiments of the present invention, including a control system for a power converter with reduced power dissipation and method of operating the same. In one embodiment, the control system includes a first controller coupled to a primary winding of a transformer and configured to control a duty cycle of a power switch to regulate an output characteristic of the power converter. The control system also includes a second controller configured to provide a signal to one of a secondary winding of the transformer and a circuit element spanning an isolation boundary of the transformer in response to a dynamic change of the output characteristic to trigger the first controller to initiate the duty cycle for the power switch.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIGS. 1 and 2 illustrate diagrams of embodiments of power converters constructed according to the principles of the present invention;

FIGS. 3 to 5 illustrate schematic diagrams of embodiments of secondary-side controllers constructed according to the principles of the present invention;

FIG. 6 illustrates a schematic diagram of an embodiment of a secondary-side controller including a one-shot pulse generator and switching lockout circuit employable with a secondary winding of a transformer of a power converter constructed according to the principles of the present invention;

FIG. 7 illustrates a partial schematic diagram of an embodiment of a power converter including a secondary-side controller with a one-shot pulse generator and switching lockout circuit constructed according to the principles of the present invention;

FIG. 8 illustrates waveform diagrams of an embodiment of selected operating parameters of the power converter of FIG. 7;

FIG. 9 illustrates a partial schematic diagram of an embodiment of a power converter including the secondary-side controller with the one-shot pulse generator and switching lockout circuit of FIG. 7;

FIG. 10 illustrates waveform diagrams of an embodiment of selected operating parameters of the power converter of FIG. 9;

FIG. 11 illustrates a schematic diagram of another embodiment of the secondary-side controller including the one-shot pulse generator and switching lockout circuit of FIG. 6; and

FIGS. 12 and 13 illustrate block diagrams of embodiments of a control system for a power converter constructed according to the principles of the present invention.

Corresponding numerals and symbols in the different figures generally refer to corresponding parts unless otherwise indicated, and may not be redescribed in the interest of brevity after the first instance. The FIGUREs are drawn to illustrate the relevant aspects of exemplary embodiments.

### DETAILED DESCRIPTION OF ILLUSTRATIVE EMBODIMENTS

The making and using of the present exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to exemplary embodiments in a specific context, namely, a power converter with reduced power dissipation. While the principles of the present invention will be described in the environment of a power converter, any application that may benefit from operation, for instance, at low load with reduced power dissipation including a power amplifier or a motor controller is well within the broad scope of the present invention.

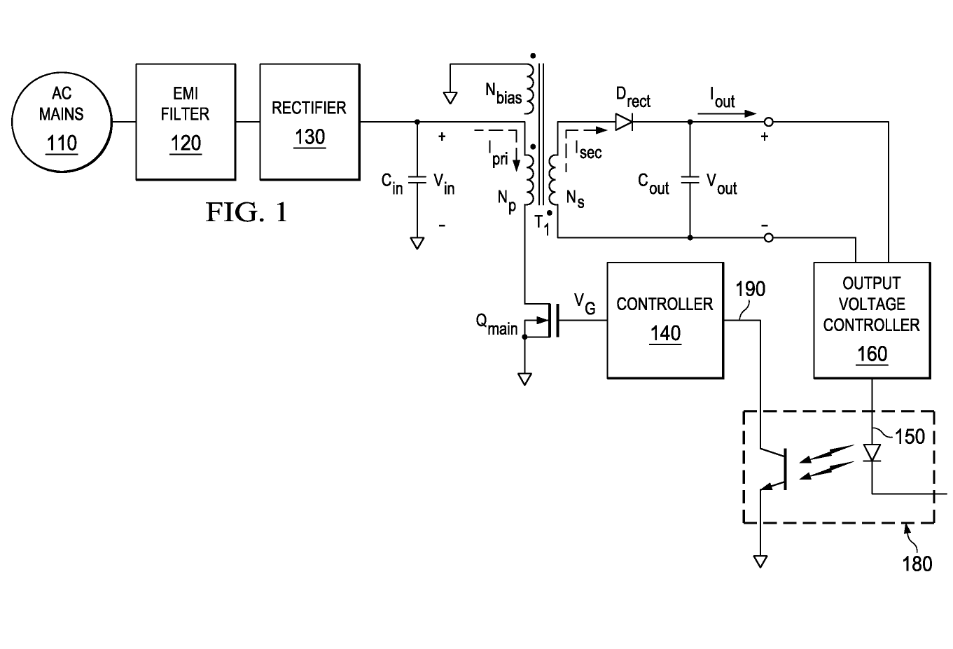

Turning now to FIG. 1, illustrated is a schematic diagram of an embodiment of a power converter constructed according to the principles of the present invention. The power converter is configured to convert ac mains voltage to a regulated dc output voltage Vₒᵤₜ. A power train (e.g., a flyback power train) of the power converter (also referred to as a “flyback power converter”) includes a power switch Qₘₐᵢₙ coupled to a source of electrical power (e.g., an ac mains 110) via an electromagnetic interference (“EMI”) filter 120, and an input filter capacitor Cᵢₙ to provide a filtered dc input voltage Vᵢₙ to a magnetic device (e.g., an isolating transformer or transformer T₁). Although the EMI filter 120 illustrated in FIG. 1 is positioned between the ac mains 110 and a bridge rectifier 130, the EMI filter 120 may contain filtering components positioned between the bridge rectifier 130 and the transformer T₁. The transformer T₁ has a primary winding Nₚ and a secondary winding Nₛ with a turns ratio that is selected to provide the output voltage Vₒᵤₜ with consideration of a resulting duty cycle and stress on power train components.

The power switch Qₘₐᵢₙ (e.g., an n-channel field-effect transistor) is controlled by a controller (e.g., a pulse-width modulator (“PWM”) controller 140) that controls the power switch Qₘₐᵢₙ to be conducting for a duty cycle. The power switch Qₘₐᵢₙ conducts in response to gate drive signal V_{G} produced by the controller 140 with a switching frequency (often designated as “fₛ”). The duty cycle is controlled (e.g., adjusted) by the controller 140 to regulate an output characteristic of the power converter such as an output voltage Vₒᵤₜ, an output current Iₒᵤₜ, or a combination thereof. A feedback path (a portion of which is identified as 150) enables the controller 140 to control the duty cycle to regulate the output characteristic of the power converter. A circuit isolation element, opto-isolator 180, (also referred to herein as an opto-coupler) is employed in the feedback path 150 to maintain input-output isolation of the power converter. The ac voltage or alternating voltage appearing on the secondary winding Nₛ of the transformer T₁ is rectified by an auxiliary power switch (e.g., diode D_{rect} or, alternatively, by a synchronous rectifier, not shown), and the dc component of the resulting waveform is coupled to the output through the low-pass output filter including an output filter capacitor Cₒᵤₜ to produce the output voltage Vₒᵤₜ. The transformer T₁ is also formed with a third winding (e.g., a bias winding) N_{bias} that may be employed to produce an internal bias voltage for the controller 140 employing circuit design techniques well known in the art. The internal bias voltage produced by the third winding N_{bias} is a more efficient process than an internal bias voltage produced by a bias startup circuit or startup circuit that typically employs a resistor with a high resistance coupled to the filtered dc input voltage Vᵢₙ to bleed a small, bias startup current therefrom.

During a first portion of the duty cycle, a primary current Iₚᵣᵢ (e.g., an inductor current) flowing through the primary winding Nₚ of the transformer T₁ increases as current flows from the input through the power switch Qₘₐᵢₙ. During a complementary portion of the duty cycle (generally co-existent with a complementary duty cycle 1-D of the power switch Qₘₐᵢₙ), the power switch Qₘₐᵢₙ is transitioned to a non-conducting state. Residual magnetic energy stored in the transformer T₁ causes conduction of a secondary current I_{sec} through the diode D_{rect} when the power switch Qₘₐᵢₙ is off. The diode D_{rect}, which is coupled to the output filter capacitor Cₒᵤₜ, provides a path to maintain continuity of a magnetizing current of the transformer T₁. During the complementary portion of the duty cycle, the magnetizing current flowing through the secondary winding Nₛ of the transformer T₁ decreases. In general, the duty cycle of the power switch Qₘₐᵢₙ may be controlled (e.g., adjusted) to maintain a regulation of or regulate the output voltage Vₒᵤₜ of the power converter.

In order to regulate the output voltage Vₒᵤₜ, a value or a scaled value of the output voltage Vₒᵤₜ is typically compared with a reference voltage using an error amplifier (e.g., in output voltage controller 160) to control the duty cycle D. The error amplifier in the output voltage controller 160 controls a current in a light-emitting diode (“LED”) of the opto-isolator 180. The error-amplifier produces an output voltage error signal in the feedback path 150 that is coupled to opto-isolator 180. The controller 140 converts a resulting current produced in a transistor of the opto-isolator 180 to control the duty cycle. This forms a negative feedback arrangement to regulate the output voltage Vₒᵤₜ to a (scaled) value of the reference voltage. A larger duty cycle implies that the power switch Qₘₐᵢₙ is closed for a longer fraction of the switching period of the power converter. Thus, the power converter is operable with a switching cycle wherein an input voltage Vᵢₙ is coupled to the transformer T₁ for a fraction of a switching period by the power switch Qₘₐᵢₙ controlled by controller 140.

The opto-isolator 180 coupled to the dc output voltage Vₒᵤₜ (an output characteristic of the power converter) thus produces an output signal 190 in accordance with an output voltage controller 160. In the error amplifier, the resulting output voltage error signal in the feedback path 150 is produced with an inverted sense of the output characteristic. For example, if the dc output voltage Vₒᵤₜ exceeds a desired regulated value (a first regulated value), the output signal 190 from the opto-isolator 180 will have a low value. Correspondingly, if the dc output voltage Vₒᵤₜ is less than the desired regulated value, the output signal 190 from the opto-isolator 180 will have a high value.

To achieve low input power for a power converter at no or light load, the controller 140 may be configured to control the output characteristic such as the dc output voltage Vₒᵤₜ to a regulated value by sensing a voltage of a winding of a transformer, such as an added winding (not shown in FIG. 1) of the transformer T₁ illustrated in FIG. 1. Sensing a voltage of a winding of a transformer T₁ avoids the need for the opto-isolator 180 to be operational, particularly at low values of the output characteristic such as the dc output voltage Vₒᵤₜ. To achieve low input power for a power converter at no or light load, it is preferable to avoid producing a continuous current in an opto-isolator 180 in a feedback loop that is employed to regulate an output voltage Vₒᵤₜ of the power converter.

In a switch-mode power converter constructed with a flyback power train, a voltage produced by a primary winding Nₚ during a flyback portion of a switching cycle can be related to the output voltage Vₒᵤₜ by accounting for a turns ratio of the transformer T₁ and voltage drops in diodes and other circuit elements. The voltage produced across the primary winding Nₚ can be employed to produce an estimate of the output voltage Vₒᵤₜ, which in turn can be used to regulate the same without crossing the isolation boundary of the transformer T₁.

The use of a primary winding to control an output voltage of a power converter such as a flyback power converter is described in BCD Semiconductor Manufacturing Limited preliminary data sheets for the AP3705 and AP3706 semiconductor controllers, the data sheets respectively entitled “Low-Power Off-Line Primary Side Regulation Controller,” March 2009, and “Primary Side Control IC For Off-Line Battery Chargers,” May 2008, which are incorporated herein by reference. Accordingly, these primary-side controllers avoid the need for an opto-isolator to regulate an isolated output voltage of a flyback power converter.

Another technique to achieve low input power for a power converter at no or light load is to reduce a switching frequency thereof to a very low level at no load or at light load, or even to temporarily stop a switching action of the power converter at no load or at light load. Whenever the switching action of the power converter is stopped, the feedback voltage is not produced by the primary winding of the transformer, which interrupts the feedback process. As a result, a response by the power converter controller to a load change is delayed until the switching action of the power converter is resumed, and the output voltage of the power converter can change considerably before the controller can react to the change in the output voltage. Processes to reduce a switching frequency of a power converter to a very low level at no load or at light load, or even to temporarily stop a switching action of the power converter are described in U.S. Patent Application Publication No. 2012/0243271, entitled “Power Converter with Reduced Power Dissipation,” published on Sep. 27, 2012, and a control system for a power converter is described in U.S. Patent Application Publication No. 2011/0305047, entitled “Control System for a Power Converter and Method of Operating the Same,” published on Dec. 15, 2011, which are incorporated herein by reference.

As introduced herein, when an output voltage of a power converter dynamically changes (e.g., drops) below a threshold level, particularly for, but not limited to, a flyback power train topology, a signal (e.g., a pulse signal or pulse) is generated by a secondary-side controller (a second controller) and transmitted across an isolation boundary of the transformer to a primary-side controller (a first controller) to immediately execute a switching action of a primary-side power switch (e.g., to initiate a duty cycle or switching period of the power switch). An output voltage is dynamically sensed by a voltage-sensing circuit that includes or is characterized by, without limitation, a low-pass frequency response or a voltage-averaging capability that enables the circuit to detect a temporal change in the sensed voltage. The control system or process (including the first and second controllers which, of course, may be integrated or separate) is particularly applicable to a power converter wherein a primary-side controller regulates an output voltage in response to a signal produced by a winding (e.g., a primary winding) of the transformer.

In one embodiment, a primary-side controller regulates the power converter output voltage in response to a feedback signal produced by a transformer winding. A secondary-side controller generates a signal (e.g., a current pulse) in an opto-isolator whenever the output voltage dynamically changes (e.g., drops), which can be independent of the absolute value of the output voltage. In an embodiment, the power converter output voltage drops below a certain voltage level to generate the current pulse in the opto-isolator. When the pulse is produced by the secondary-side controller, an opto-isolator generates a corresponding pulse at an input terminal of the primary-side controller. Then the primary-side controller quickly activates the power switch during a first portion of the duty cycle for one pulse (e.g., initiates a duty cycle for the power switch), which enables the primary-side controller to detect the output voltage during a complementary portion of the duty cycle. After the primary-side controller detects the output voltage during the complementary portion, it can control the output voltage to the desired level. The controller on the secondary side (the secondary-side controller) returns the opto-isolator to a low-current mode a short time after the pulse is produced, with no substantial continuing current in the opto-isolator. As a result, an average current in the opto-isolator is almost zero, even if the peak current in the opto-isolator is high during the pulse. A high peak current in the opto-isolator diode may be employed to enable a faster response time from the opto-isolator.

As a result, the secondary-side controller introduced herein produces no substantial current in the opto-isolator during normal operation when the output voltage has not dropped, which enables the no-load power of the power converter to be very low. When the output voltage drops, for example, in response to a sudden increase of a load current coupled to the power converter, the switching action of the primary-side controller is triggered by a pulse produced by the secondary-side controller. As a result, the primary-side controller can react to the sudden load current increase to immediately start the switching action of a primary-side power switch (e.g., initiate a duty cycle or a switching period of the power switch). The secondary-side controller activates the primary-side controller essentially immediately after the output voltage dynamically drops. The output voltage does not need to drop below a controlled voltage level for the secondary-side controller to produce the pulse. The secondary-side controller can be configured to operate with different output voltages without substantial change. An adjustment to the primary-side control loop is not necessary. The opto-isolator is not part of the normal feedback loop that senses the output voltage or produces an estimate therefor, so it does not directly affect stability of the output voltage control, and loop compensation is not necessary in the secondary-side controller. Accordingly, the opto-isolator can be activated very quickly in response to a drop in the output voltage. In an embodiment, the pulse produced by the secondary-side controller can be transferred from the secondary side to the primary side via a transformer or a capacitor or other circuit isolation element (or other isolation means) in place of an opto-isolator.

Turning now to FIG. 2, illustrated is a schematic diagram of an embodiment of a power converter constructed according to the principles of the invention. The power circuit topology illustrated in FIG. 2 is a flyback circuit topology. A transformer TX2 is formed with a primary winding P1 coupled to a power switch Qₘₐᵢₙ. The power switch Qₘₐᵢₙ is normally controlled by a gate control signal produced at pin G of a primary-side controller 240 with a duty cycle D at a switching frequency fₛ such as 100 kilohertz (“kHz”). The duty cycle D is adjusted by the primary-side controller 240 to regulate an output characteristic (e.g., an output voltage Vₒᵤₜ) at a desired level. The output voltage Vₒᵤₜ is estimated by the primary-side controller 240 by sensing a voltage across a primary winding P2 during a complementary duty cycle 1-D. The current in the power switch Qₘₐᵢₙ is sensed with a current-sense resistor R2, and a resulting current-sense signal is coupled to the input pin Ip of the primary-side controller 240. The primary-side controller 240 employs the current-sense signal coupled to the current-sense input pin Ip to produce current-mode control for the duty cycle D of the power switch Qₘₐᵢₙ. The voltage produced by the primary winding P2 during the complementary duty cycle 1-D is sensed with a voltage-divider network formed with resistors R4, R5. The sensed voltage is coupled to the feedback pin FB of the primary-side controller 240 to regulate the output voltage Vₒᵤₜ. In the circuit arrangement illustrated in FIG. 2, an opto-isolator (or opto-coupler) 250 is thereby not needed to feed back the output voltage Vₒᵤₜ to the primary-side controller 240. The primary winding P2 is also employed to produce an internal bias voltage for the power converter by a bias circuit including diode D8 and filter capacitor C3.

To reduce energy losses at no or light output loads, the switching frequency fₛ is reduced, or, alternatively, the primary-side controller 240 is operated in a burst mode. In such an arrangement, if the load current of the power converter is suddenly increased when the switching frequency fₛ is reduced or when the primary-side controller 240 is operated in a burst mode, a long period of time may transpire before a new gate control signal is applied to the gate of the power switch Qₘₐᵢₙ. Accordingly, the output voltage Vₒᵤₜ can drop below a desired voltage level when such load is suddenly applied to the power converter in such an operating condition.

As introduced herein, a pulsed feedback signal provided by an opto-isolator 250 is connected to a feedback pin FB2 of the primary-side controller 240 as illustrated in FIG. 2. The pulsed feedback signal is initiated by a secondary-side controller 260, and is an indicator for a change (e.g., drop) in the output voltage Vₒᵤₜ, which can be a dynamic voltage drop or a voltage drop below a threshold level. The pulsed feedback signal at pin FB2 triggers the primary-side controller 240 to initiate a new duty cycle without the need to wait for a normal clock or other control signal to initiate a new duty cycle, or for the end of the current switching period. The resistor R13 provides a load for the opto-isolator 250.

In an embodiment, the pulsed feedback signal from the opto-isolator 250 is connected to the feedback pin FB of the primary-side controller 240. If the pulsed feedback signal from the opto-isolator 250 is connected to the feedback pin FB, it should have a higher amplitude than the normal feedback signal produced by the primary winding P2 so that it can be distinguished by the primary-side controller 240 from the normal feedback signal.

Detection of the pulsed feedback signal from the opto-isolator 250 can be disabled for a brief interval of time after the power switch Qₘₐᵢₙ is transitioned off. It may be necessary to implement a high-pass resistor-capacitor network between the opto-isolator 250 and the primary-side controller 240 to limit duration of the pulsed feedback signal produced by the opto-isolator 250 due to the inherent charge storage time of the opto-isolator 250. Once the opto-isolator 250 is transitioned on, it will ordinarily take some time until its switch (e.g., transistor) can be fully turned off, even if there is no current in its light-emitting diode. During that time, a current in the opto-isolator 250 may influence the feedback process in an unwanted way. A resistor-capacitor circuit could prevent a current in the opto-isolator 250 from influencing the pulsed feedback signal. When the opto-isolator 250 is connected to the feedback pin FB2, similar precautions of disabling the pulsed feedback signal from the opto-isolator 250 may be necessary such as when it is connected to the feedback pin FB. In this case, the feedback pins FB, FB2 illustrated in FIG. 2 are the same pin.

In an embodiment, in place of an opto-isolator 250, the pulsed feedback signal generated by the secondary-side controller 260 can be transferred via a pulse transformer in place of the opto-isolator 250. The pulsed feedback signal again needs to be distinguished from a normal feedback voltage when the pulsed feedback signal is coupled to the feedback pin FB. A pair of Y-capacitors (i.e., capacitors with sufficient safety-isolation voltage rating to span the isolation boundary of the power converter) could also be used to transfer the pulsed feedback signal from the secondary-side controller 260 to the primary-side controller 240.

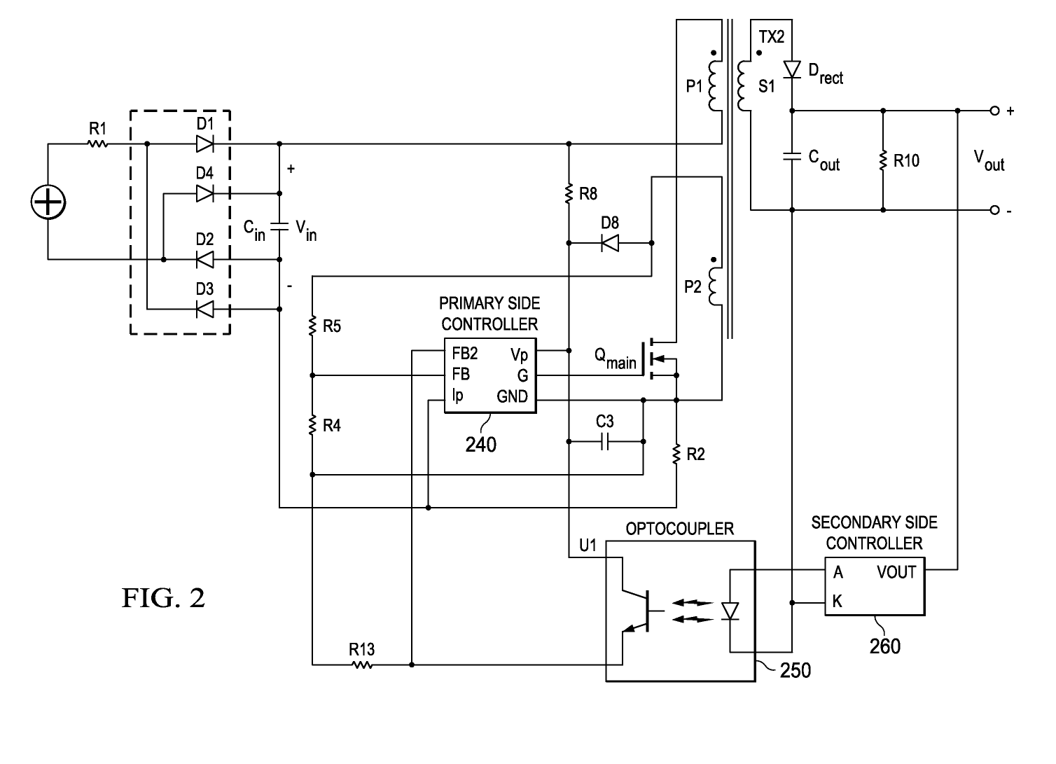

Turning now to FIG. 3, illustrated is a schematic diagram of an embodiment of a secondary-side controller constructed according to the principles of the invention. A secondary-side controller is configured to detect a dynamic voltage change (e.g., a rapid drop in voltage) of an output voltage Vₒᵤₜ of a power converter. By detecting a dynamic voltage drop rather than detecting a voltage drop below a fixed threshold voltage, the circuit is adaptable to a range of power converter output voltages Vₒᵤₜ without further adjustment.

A dynamic voltage drop can be implemented in a circuit to detect a percentage voltage drop in a short interval of time of a sensed output voltage Vₒᵤₜ of the power converter. The circuit can compare voltages at output nodes of two voltage-divider networks. The first voltage-divider network is constructed to produce an output voltage Vₒᵤₜ with minimal time delay, for example, with minimal filtering. The second voltage-divider network is constructed to produce an output voltage with intended delay, for example, by coupling one terminal of a capacitor to the voltage-divider output node and the other terminal of the capacitor to an end terminal of the voltage-divider network. In this manner, a percentage drop that occurs in a short interval of time in a sensed output voltage Vₒᵤₜ can be detected. A dynamic voltage sensing circuit is adaptable without alteration to a power converter with an adjustable output voltage Vₒᵤₜ an output voltage Vₒᵤₜ that is altered by a remote-sense voltage regulating arrangement. A slowly varying output voltage Vₒᵤₜ will not be detected by the dynamic voltage sensing circuit. Circuits constructed employing techniques of the prior art require an adjustment of one reference voltage on the primary side of the power converter and another reference voltage on the secondary side of the power converter when the output voltage changes.

As illustrated in FIG. 3, the output voltage Vₒᵤₜ of the power converter is sensed with a first voltage-divider network formed with resistors R4, R5, and a second voltage-divider network formed with resistors R7, R8 and a capacitor C2. The voltages produced at the node between the resistors R4, R5 and at the node between the resistors R7, R8 are coupled respectively to the inverting and non-inverting inputs of a comparator 310. The capacitor C2 acts as a low-pass filter for the voltage at the node between the resistors R7, R8 to provide capability to detect a dynamically changing voltage. In an exemplary embodiment, the resistance ratio R8/(R7+R8) of the resistors R7, R8 is slightly less than the resistance ratio R4/(R4+R5) of the resistors R4, R5 to allow the output of the comparator 310 to be high when no dynamic voltage drop occurs for the output voltage Vₒᵤₜ. If the output voltage Vₒᵤₜ slowly falls, the output of the comparator 310 is not transitioned to a high state. Thus, the comparator 310 detects a dynamic/rapid voltage drop of the output voltage Vₒᵤₜ. The comparator 310 may be formed with small hysteresis to ensure fast switching with a full transition of its output voltage whenever a dynamic voltage drop of the output voltage Vₒᵤₜ occurs.

The output of the comparator 310 is coupled to a high-pass network formed with a capacitor C1 and a resistor R16. The high-pass network produces a short-duration pulse at the output terminal “A” of the secondary-side controller, which is coupled to the light-emitting diode of opto-isolator 250 illustrated in FIG. 2. In this manner and with continuing reference to FIG. 2, when the output voltage Vₒᵤₜ dynamically drops, a pulsed feedback signal is immediately transmitted to the feedback pin FB2 of the primary-side controller 240 by the opto-isolator 250. In an exemplary embodiment, the resistance ratio R8/(R7+R8) of the resistors R7, R8 is slightly greater than the resistance ratio R4/(R4+R5) of the resistors R4, R5, and the output of the comparator 310 will go high when there is a dynamic voltage decrease for the output voltage Vₒᵤₜ.

Turning now to FIG. 4, illustrated is a schematic diagram of an embodiment of a secondary-side controller constructed according to the principles of the invention. The secondary-side controller is constructed with discrete components and, similar to the circuit illustrated in FIG. 3, is configured to detect a dynamic voltage change (e.g., drop) of the output voltage Vₒᵤₜ of the power converter. Similar to the circuit illustrated in FIG. 3, the resistance ratio R2/(R2+R4) of the resistors R2, R4 is slightly smaller than the resistance ratio R14/(R14+R11) of the resistors R11, R14 to ensure that a switch Q6 is turned on when no dynamic voltage drop in the output voltage Vₒᵤₜ occurs.

Turning now to FIG. 5, illustrated is a schematic diagram of an embodiment of a secondary-side controller constructed according to the principles of the invention. The secondary-side controller illustrated in FIG. 5 shows an example of a controller with a fixed voltage reference that detects when the output voltage Vₒᵤₜ drops below a desired voltage level set by a Zener diode D_{Zener} and the voltage-divider network formed with resistors R4 and R5. In addition, the circuit illustrated in FIG. 5 is configured to detect a dynamic voltage change (e.g., drop) of the output voltage Vₒᵤₜ of the power converter provided by inclusion of a resistor R1 and a capacitor C2. To detect when the output voltage Vₒᵤₜ drops below a desired voltage level, the resistance values of the voltage-divider resistors R4, R5 are selected in a conventional manner in conjunction with the breakdown voltage of the Zener diode D_{Zener} to enable a comparator 510 to detect when the output voltage Vₒᵤₜ drops below the desired voltage level to enable the secondary-side controller to produce a signal for the primary-side controller when that event occurs. The comparator 510 may be formed with a small hysteresis to ensure fast switching with a full transition of its output voltage whenever a voltage drop in the output voltage Vow occurs.

In the case of a small or slow increase of load current, the increased load current is detected when the output voltage Vₒᵤₜ drops below a fixed voltage level (a threshold level) set by the Zener diode D_{Zener} and the resistors R4, R5. The ability to detect a small or slow increase of load current enables operation of the power converter at an even lower switching frequency at no load because the secondary-side controller can detect a smaller load current than a dynamic circuit alone. For a fast increase of load current, the dynamic change of the output voltage Vₒᵤₜ is detected. This provides a faster reaction time to a large load change than a secondary-side controller with only a fixed voltage reference. The resistor R1 has almost no effect at the fixed voltage level because the voltage difference between the inverting and non-inverting inputs of the comparator 510 is substantially zero volts when it switches, so there is almost no current in the resistor R1.

When the output voltage is higher, the resistor R1 reduces the voltage at the resistor R4 (compared to the same circuit without the resistor R1), so that there is only a small difference between the voltages at the inputs of the comparator 510. As a result, a small drop of the output voltage Vₒᵤₜ is sufficient to cause the comparator 510 to switch its output to high because the capacitor C2 transfers the dynamic change of the output voltage Vₒᵤₜ to the inverting input of the comparator 510. Thus, the secondary-side controller is configured to provide a pulsed feedback signal in response to a decrease of an output characteristic (e.g., the output voltage Vₒᵤₜ) below a threshold level.

Thus, a control system for a power converter with reduced power dissipation at light loads and method of operating the same has been introduced herein. In one embodiment, the control system includes a first controller (e.g., a primary-side controller) configured to control a duty cycle of a power switch to regulate an output characteristic of the power converter. The control system also includes a second controller (e.g., a secondary-side controller) configured to provide a signal in response to a dynamic change of the output characteristic to the first controller to initiate the duty cycle for the power switch.

As introduced herein, at light load or at no load, a power converter enters a sleep mode wherein a switching operation of a power switch is temporarily halted. As a result, an output characteristic such as an output voltage drifts downward during the sleep mode. During the sleep mode, voltage is not applied to a transformer of the power converter. A secondary-side controller detects the downward drift of the output characteristic such as an output voltage drifting lower than a threshold voltage level, and switches a secondary winding of the transformer such as an auxiliary winding with a one-shot pulse generator to ground or to a bias voltage depending on the secondary-side circuit arrangement. The voltage pulse (i.e., a pulse signal) resulting from switching the secondary winding is detected on the primary side of the transformer, which pulse appearing on the primary side of the transformer is employed to wake up the primary-side controller to terminate the sleep mode and resume the switching operation of the power switch.

By employing the transformer to transfer the pulse to the primary side, the need for a separate circuit element such as an opto-isolator or a pulse transformer to bridge the power converter primary-to-secondary isolation barrier is avoided. A one-shot pulse generator and switching lockout circuit of the secondary-side controller is employed to apply a signal (e.g., the pulse) to the transformer and is constructed with a switching lock-out feature so that the pulse is not triggered after a normal load step response when the output characteristic drops below the threshold level and the power converter is still switching. The one-shot pulse generator prevents the secondary-side controller from inadvertently switching the secondary winding to ground or to the bias voltage with the one-shot pulse generator and switching lockout circuit while the primary side is delivering power.

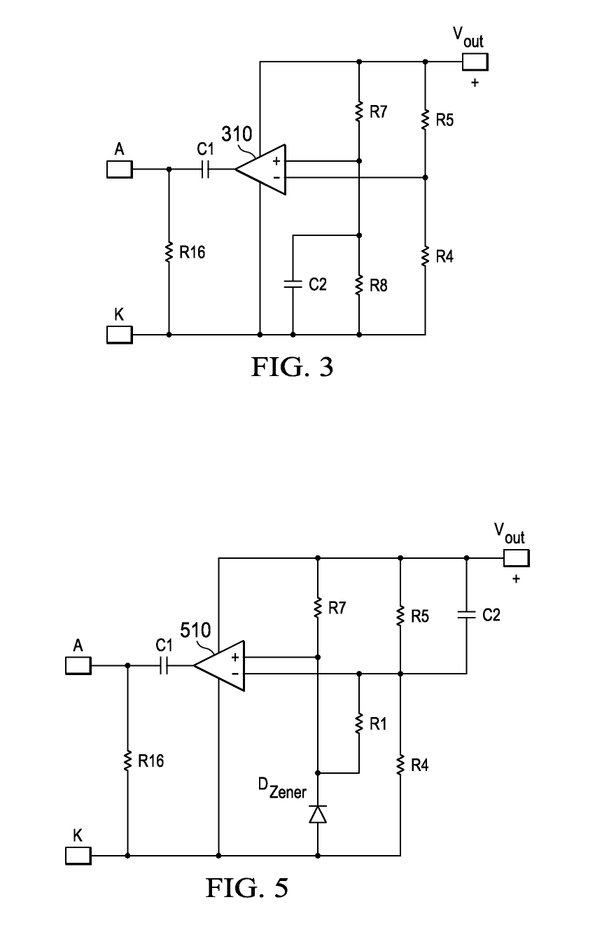

Turning now to FIG. 6, illustrated is a schematic diagram of an embodiment of a secondary-side controller including a one-shot pulse generator and switching lockout circuit employable with a secondary winding of a transformer of a power converter constructed according to the principles of the present invention. As an example, the secondary-side controller can be used with an inductor-inductor-capacitor (“LLC”) or flyback power-train topology wherein the secondary side employs a low-side synchronous rectifier to rectify a voltage from a winding of a transformer to produce a dc output voltage Vout. A circuit node “Wake” illustrated in FIG. 6 is coupled to one terminal of a secondary winding of a transformer (e.g., the winding S1 of the transformer TX2 illustrated and described hereinabove with reference to FIG. 2), and the other terminal of the secondary winding is coupled to a positive output voltage terminal of the power converter (e.g., the positive output node for the output voltage Vout). When an N-channel metal-oxide semiconductor field-effect transistor (“MOSFET”) M9 is turned on for a brief interval of time by the one-shot pulse generator and switching lockout circuit, the power converter output voltage Vout is applied as a pulse across the secondary winding of the transformer. Recall that the main power switch (e.g., the power switch Qₘₐᵢₙ illustrated and described hereinabove with reference to FIG. 2) is off during a sleep mode of the power converter and, accordingly, no primary-side voltage is applied to the transformer. When the power converter is in a sleep mode, a voltage pulse applied to a secondary winding of the transformer can be detected by a comparator on the primary side of the transformer.

A reference voltage and wake-up comparator 610 is formed with a TL431 programmable reference (U2) that operates as a voltage comparator to detect the output voltage Vout falling below a threshold voltage level. The output of reference voltage and wake-up comparator 610 is coupled to a gate terminal of a P-channel MOSFET Q2 of an inverter 615. When the output voltage Vout falls below the threshold voltage level, the gate of P-channel MOSFET Q2 is pulled down, thereby turning the switch on. An output of the inverter 615 is coupled to an input of a totem pole buffer 630. An output of the totem pole buffer 630 is coupled to the one-shot pulse generator 640, the output of which briefly turns on the N-channel MOSFET M9, which applies the pulsed voltage across the secondary winding of the transformer.

When the power converter is not in a sleep mode, the switching lockout circuit 620 employs a diode pair D1 to rectify an alternating voltage applied to the node Wake by the secondary winding of the transformer and sensed by a capacitor C7, which is rectified to produce a bias voltage across a capacitor C8. This bias voltage produced across the capacitor C8 turns on an N-channel MOSFET M10 to lock out turning on the N-channel MOSFET M9. Turning on the N-channel MOSFET M10 locks out the action of the totem pole buffer 630, which disables operation thereof. Thus, when the power switch is actively switching (e.g., during normal operation), the switching lockout circuit 620 prevents turning on or disables the one-shot pulse generator 640 to produce a signal or pulse across the transformer. When the power switch is not actively switched, the N-channel MOSFET M9 produces a voltage pulse across the transformer that can be detected by a comparator on the primary side of the transformer.

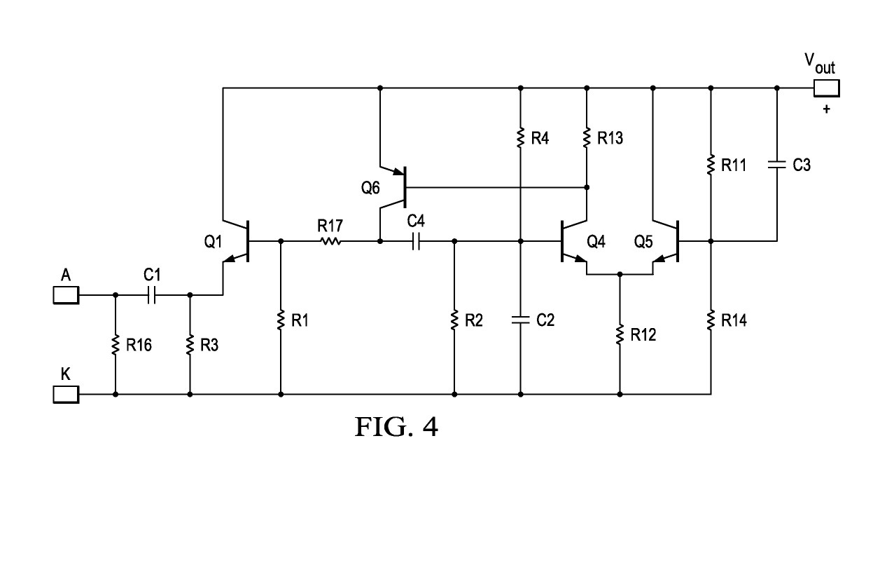

Turning now to FIG. 7, illustrated is a partial schematic diagram of an embodiment of a power converter including a secondary-side controller with a one-shot pulse generator and switching lockout circuit 720 constructed according to the principles of the present invention. The secondary side of the power converter employs a low-side synchronous rectifier to rectify a voltage from a winding of a transformer to produce a dc output voltage Vout. The one-shot pulse generator and switching lockout circuit 720 is employed to apply a signal (e.g., a voltage pulse) to a secondary winding S1 of a transformer TX2 to wake up or trigger a primary side controller. The power converter is formed with the transformer TX2 that provides metallic isolation between a primary and secondary side of the power converter. The transformer TX2 includes a primary winding P1 switched by a power switch 750 and the secondary winding S1, a voltage of which is rectified to produce the dc output voltage Vout of the power converter. The secondary side of the power converter includes the one-shot pulse generator and switching lockout circuit 720 coupled to a switch 710, which closes the switch 710 (i.e., causes the switch 710 to conduct) during a brief interval of time to produce a voltage pulse across the secondary winding S1 when the output voltage Vout declines below a threshold voltage level. The switch 710 can be a synchronous rectifier switch that is ordinarily included for rectification of an ac voltage in a high-efficiency circuit. The switch 710 can be, without limitation, an N-channel MOSFET.

The primary side of the transformer TX2 is formed with a primary winding P2 that is coupled to a primary-side controller such as the primary side controller 240 described previously hereinabove with respect to FIG. 2 that estimates the output voltage Vout by sensing a voltage across the primary winding P2 during a complementary duty cycle 1-D of the power switch 750. A voltage produced across the primary winding P2 is also rectified by a diode Dbias to produce a bias voltage Vaux. The voltage produced across the primary winding P2 is also sensed by a comparator 730 during a sleep period of the power converter to produce a sleep termination signal (or wake-up signal) 740 that can be employed to terminate the sleep period of the power converter.

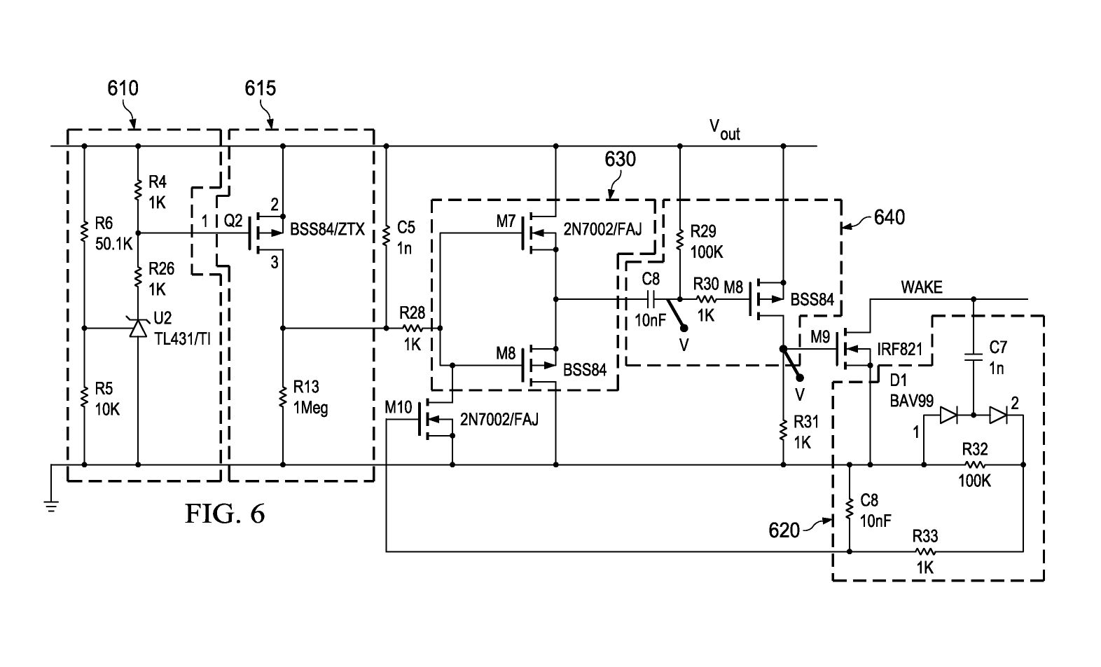

Turning now to FIG. 8, illustrated are waveform diagrams of an embodiment of selected operating parameters of the power converter of FIG. 7. The waveform “B” represents a voltage across a winding of the transformer TX2. When the power converter is actively switching, the one-shot pulse generator and switching lockout circuit 720 enters a lockout mode as illustrated by the waveform “A” as a lockout region that disables closure of the switch 710. When the power converter is actively switching, the output voltage Vout is regulated at a desired voltage level by the primary-side controller. When active switching stops, the output voltage Vout droops until it crosses the threshold voltage level, at which time the one-shot pulse generator and switching lockout circuit 720 produces a pulse to terminate the sleep mode of the power converter, as illustrated by the waveform “A” as one-shot pulse, that is detected by the comparator 730 on the primary side of the power converter to trigger the primary-side controller. When the switching action again starts, the one-shot pulse generator and switching lockout circuit 720 re-enters the lockout mode that disables closure of the switch 710.

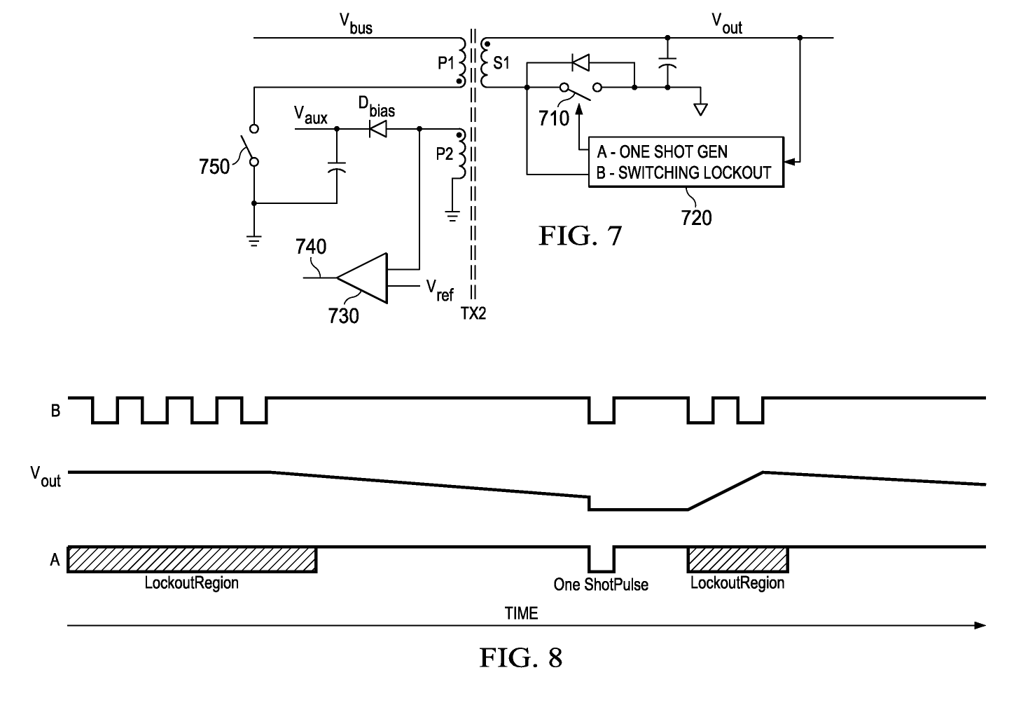

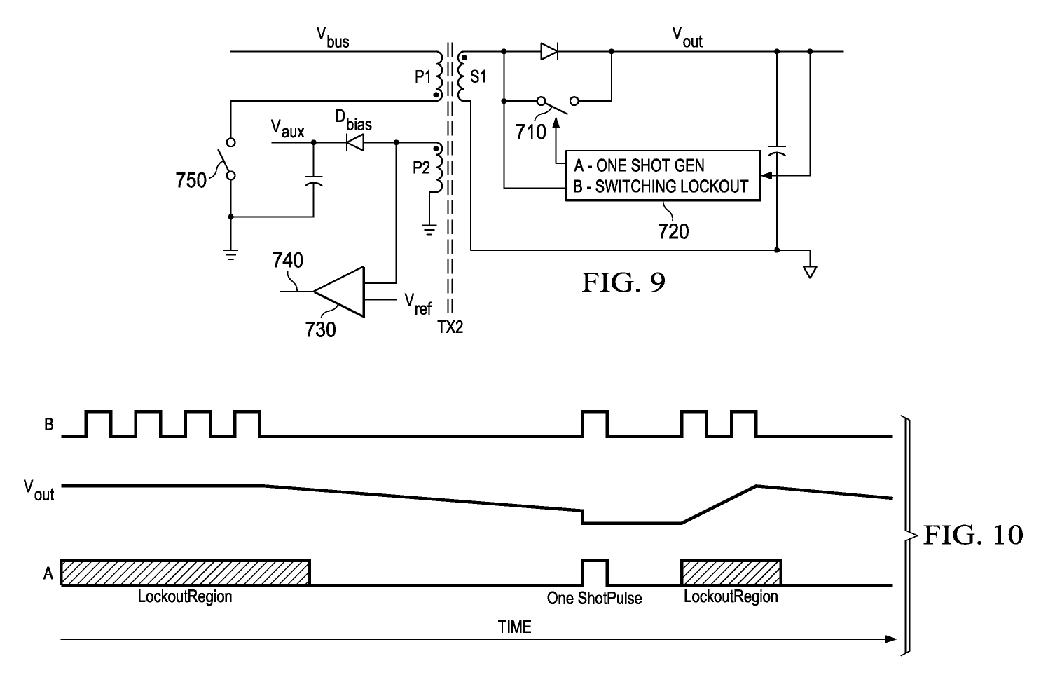

Turning now to FIG. 9, illustrated is a partial schematic diagram of an embodiment of a power converter including the secondary-side controller with the one-shot pulse generator and switching lockout circuit 720 of FIG. 7. The secondary side of the power converter employs a high-side synchronous rectifier to rectify a voltage from a winding of a transformer to produce a dc output voltage Vout. The power converter illustrated in FIG. 9 operates in a manner similar to that illustrated and described hereinabove with reference to FIGS. 7 and 8 and, as such, the operation will not repeated herein in the interest of brevity. In accordance therewith, FIG. 10 illustrates waveform diagrams of an embodiment of selected operating parameters of the power converter of FIG. 9.

Alternatives to using a transformer to transmit a pulse across the isolation boundary to terminate a sleep mode include a Y-capacitor, a pulse transformer, or an opto-isolator to span the power converter isolation boundary and transmit a pulse to wake up or trigger the primary-side controller on the primary side of the power converter. It is noted that the number of pins needed to implement an LLC topology is important for constructing a high-density power converter at low cost. By employing the transformer of the power converter to transmit a voltage pulse from the secondary side of the power converter to the primary side, the number of parts used to span the power converter isolation barrier is reduced. This provides a convenient and easily controlled process for waking up the primary-side controller during, for instance, light load or no-load operation so that the primary-side controller can operate in a sleep mode without having to wake up from time to time to sample a feedback pin that represents an output characteristic.

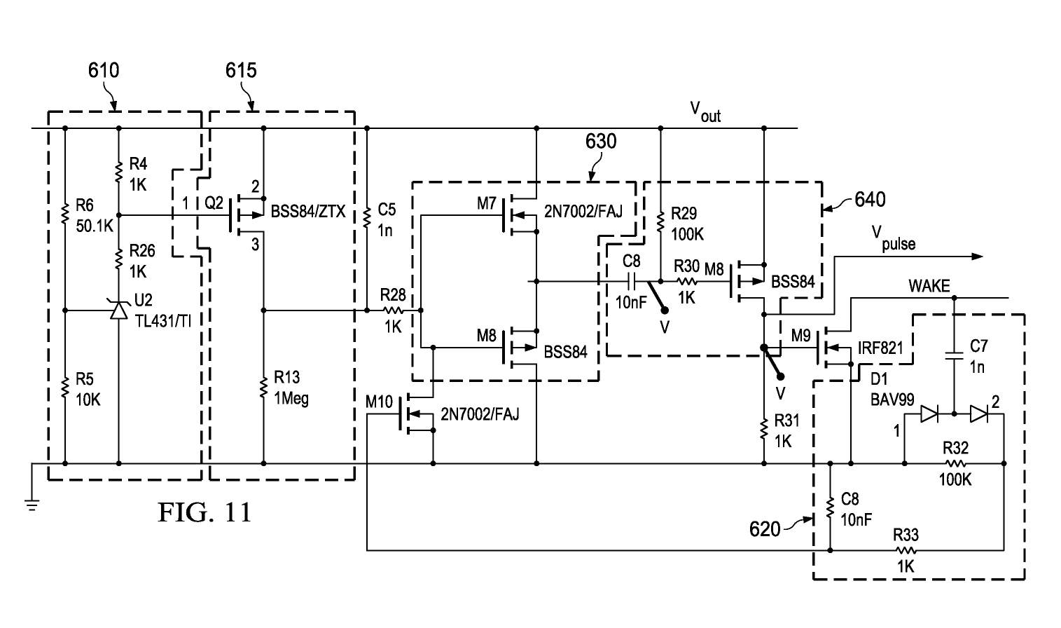

Turning now to FIG. 11, illustrated is a schematic diagram of another embodiment of the secondary-side controller including the one-shot pulse generator and switching lockout circuit of FIG. 6. In addition to the functionality described above with respect to FIG. 6, the one-shot pulse generator 640 produces a pulse signal (also referred to as a “pulsed feedback signal”) Vpulse that can be employed to enable transmitting a wake-up or trigger signal to a primary-side controller such as the primary-side controller 240 illustrated in FIG. 2.

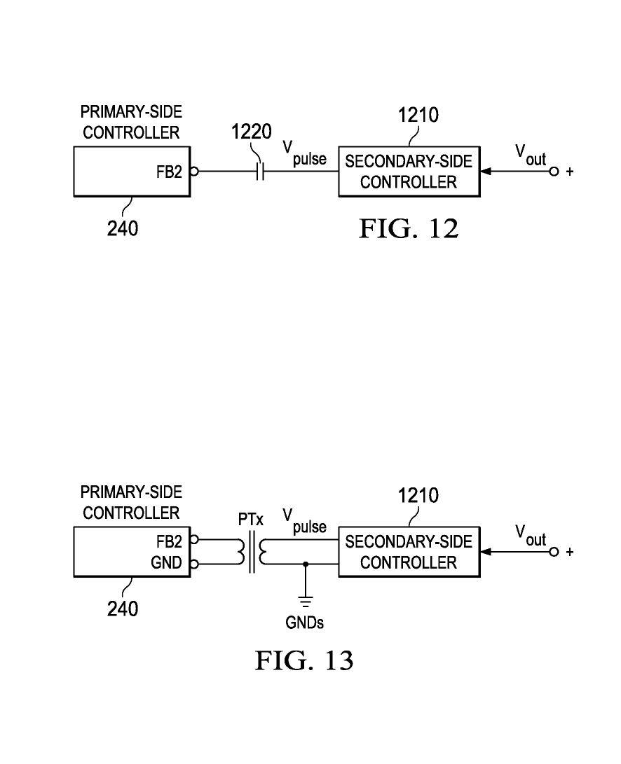

Turning now to FIG. 12, illustrated is a block diagram of an embodiment of a control system for a power converter constructed according to the principles of the present invention. With continuing reference to FIGS. 2, 6 and 11, the control system includes a primary-side controller 240 and a secondary-side controller 1210 including the switching lockout circuit 620 and a one-shot pulse generator 640. The one-shot pulse generator 640 and switching lockout circuit 620 described hereinabove with reference to FIGS. 6 and 11 is employed in conjunction with an isolation boundary spanning circuit element to provide a pulse signal Vpulse to wake up or trigger the primary side controller 240.

As described hereinabove with reference to FIG. 2, the power converter duty cycle D is adjusted by the primary-side controller 240 to regulate output voltage Vout at a desired voltage level. The output voltage Vₒᵤₜ is estimated by the primary-side controller 240 by sensing a voltage across a primary winding P2 of the transformer TX2 during a complementary duty cycle 1-D. The circuit illustrated in FIG. 12 regulates the output voltage Vout of the power converter in a manner similar to that described hereinabove with reference to FIG. 2 and will not be redescribed herein in the interest of brevity.

The circuit illustrated in FIG. 2 employs an opto-isolator/coupler 250 to produce a pulsed feedback signal at pin FB2 of the primary-side controller 240 to trigger the primary-side controller 240 to initiate a new duty cycle without a need to wait for a normal clock or other control signal to initiate a new duty cycle, or for the end of the current switching period. The circuit illustrated in FIG. 12 employs Y-capacitor 1220 as the isolation boundary spanning circuit element in place of the opto-isolator/coupler 250 to couple the pulse signal Vpulse produced by the secondary-side controller 1210 to the feedback pin FB2 of the primary-side controller 240 to trigger the primary-side controller 240 to initiate a new duty cycle. A Y-capacitor 1220 is a capacitor with sufficient voltage rating to safely span the isolation boundary between primary and secondary sides of the power converter.

Turning now to FIG. 13, illustrated is a block diagram of another embodiment of the control system of FIG. 12. Again, with continuing reference to FIGS. 2, 6 and 11, the control system includes the primary-side controller 240 and the secondary-side controller 1210 including the switching lockout circuit 620 and the one-shot pulse generator 640. The one-shot pulse generator 640 and switching lockout circuit 620 described hereinabove with reference to FIGS. 6 and 11 is employed in conjunction with an isolation boundary spanning circuit element such as pulse transformer PTx to provide a pulse signal Vpulse to wake up or trigger the primary side controller 240. The pulse transformer PTx provides the signal to wake up the primary-side controller 240, e.g., in a flyback power train topology. The isolation boundary-spanning pulse transformer PTx is used in place of an opto-isolator/coupler or the Y-capacitor to couple the pulse signal Vpulse to the feedback pin FB2 of the primary-side controller 240 to trigger the primary-side controller 240 to initiate a new duty cycle. One winding of the pulse transformer PTx is coupled between the pulse signal Vpulse and a secondary-side ground GNDs. The other winding of the pulse transformer PTx is coupled between the feedback pin FB2 and a ground pin GND of the primary-side controller 240 (i.e., primary-side circuit ground).

Thus, a control system for a power converter with reduced power dissipation and method of operating the same has been introduced herein. In one embodiment, the control system includes a first controller (e.g., a primary-side controller) coupled to a primary winding of a transformer and configured to control a duty cycle of a power switch to regulate an output characteristic of the power converter. The control system also includes a second controller (e.g., a secondary-side controller) configured to provide a signal to one of a secondary winding of the transformer and a circuit element spanning an isolation boundary of the transformer in response to a dynamic change of the output characteristic to trigger the first controller to initiate the duty cycle for the power switch

The processes described hereinabove of applying a voltage pulse to a secondary winding or other means of isolating a primary-to-secondary isolation boundary such as a Y-capacitor or a pulse transformer during, for instance, a complementary portion of a duty cycle of the power converter can be employed with many power converter power train topologies such as a flyback, forward, bridge, and LLC topologies. Those skilled in the art should understand that the previously described embodiments of a power converter and control system and related methods of operating the same are submitted for illustrative purposes only. While the principles of the present invention have been described in the environment of a power converter, these principles may also be applied to other systems such as, without limitation, a power amplifier or a motor controller. For a better understanding of power converters, see “Modern DC-to-DC Power Switch-mode Power Converter Circuits,” by Rudolph P. Severns and Gordon Bloom, Van Nostrand Reinhold Company, New York, N.Y. (1985) and “Principles of Power Electronics,” by J. G. Kassakian, M. F. Schlecht and G. C. Verghese, Addison-Wesley (1991).

Also, although the present invention and its advantages have been described in detail, it should be understood that various changes, substitutions, and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A control system for a power converter, comprising:
a first controller coupled to a primary winding of a transformer and configured to control a duty cycle of a power switch to regulate an output characteristic of said power converter; and
a second controller configured to provide a signal to one of a secondary winding of said transformer and a circuit element spanning an isolation boundary of said transformer in response to a dynamic change of said output characteristic to trigger said first controller to initiate said duty cycle for said power switch.

2. The control system as recited in claim 1 wherein said circuit element is one of a Y-capacitor and a pulse transformer.

3. The control system as recited in claim 1 wherein said signal is a pulsed feedback signal.

4. The control system as recited in claim 1 wherein said second controller is configured to provide said signal during a complementary duty cycle of said power converter.

5. The control system as recited in claim 1 wherein said second controller is configured to provide said signal in response to a decrease of said output characteristic below a threshold level.

6. The control system as recited in claim 1 wherein said second controller comprises a one-shot pulse generator and a switching lockout circuit.

7. The control system as recited in claim 6 wherein said one-shot pulse generator causes a switch to conduct to provide said signal.

8. The control system as recited in claim 6 wherein said switching lockout circuit disables said one-shot pulse generator when said power switch is actively switching.

9. A power converter, comprising:
a transformer including a primary winding and a secondary winding;
a power switch coupled to said primary winding; and
a control system, comprising:
a first controller coupled to said primary winding and configured to control a duty cycle of said power switch to regulate an output characteristic of said power converter, and
a second controller configured to provide a signal to one of said secondary winding and a circuit element spanning an isolation boundary of said transformer in response to a dynamic change of said output characteristic to trigger said first controller to initiate said duty cycle for said power switch.

10. The power converter as recited in claim 9 wherein said circuit element is one of a Y-capacitor and a pulse transformer.

11. The power converter as recited in claim 9 wherein said signal is a pulsed feedback signal.

12. The power converter as recited in claim 9 wherein said second controller is configured to provide said signal during a complementary duty cycle of said power converter.

13. The power converter as recited in claim 9 wherein said second controller is configured to provide said signal in response to a decrease of said output characteristic below a threshold level.

14. The power converter as recited in claim 9 wherein said second controller comprises a one-shot pulse generator and a switching lockout circuit.

15. The power converter as recited in claim 14 wherein said one-shot pulse generator causes a switch to conduct to provide said signal.

16. The power converter as recited in claim 14 wherein said switching lockout circuit disables said one-shot pulse generator when said power switch is actively switching.

17. A method of operating a power converter, comprising:
controlling a duty cycle of a power switch to regulate an output characteristic of said power converter with a first controller coupled to a primary winding of a transformer; and
providing a signal to one of a secondary winding of said transformer and a circuit element spanning an isolation boundary of said transformer with a second controller in response to a dynamic change of said output characteristic to trigger said first controller to initiate said duty cycle for said power switch.

18. The method as recited in claim 17 wherein said signal is a pulsed feedback signal.

19. The method as recited in claim 17 wherein said second controller provides said signal during a complementary duty cycle of said power converter.

20. The method as recited in claim 17 wherein said second controller provides said signal in response to a decrease of said output characteristic below a threshold level.
